(19) United States
(12) Patent Application Publication
(10) Pub. No.: US 2017/0189273 A1
(43) Pub. Date: Jul. 6, 2017

(54) TRUNCATED FEEDING TUBE

(71) Applicants: PING-I HSU, KAOHSIUNG CITY (TW); CHANG-BIH SHIE, TAINAN CITY (TW)

(72) Inventors: PING-I HSU, KAOHSIUNG CITY (TW); CHANG-BIH SHIE, TAINAN CITY (TW)

(21) Appl. No.: 14/985,787

(22) Filed: Dec. 31, 2015

(51) Int. Cl. A61J 15/00

(52) U.S. Cl. CPC A61J 15/008; A61J 15/003; A61J 15/0003

(57) ABSTRACT

The invention relates to a truncated feeding tube comprising a first tube, a second tube, and a joint element. One terminal of the first tube and the second tube is removably connected to the two terminals of the joint element. A patient can connect the first and second tubes by the joint element or remove the second tube. Since the joint element can be separated from the first and second tubes, the joint member can be simply replaced when it is damaged without replacing the first or second tube. A positioning member is disposed on a front portion of the second tube, so that an endoscopic technology can be used to clamp the positioning member and the inner wall of the stomach or the duodenum by a hemostatic clip, and the front portion of the second tube is positioned in the stomach or the duodenum to avoid sliding displacement.

### BACKGROUND

Field of Invention

The disclosure relates to a truncated feeding tube, especially a fixing structure of a two-segment feeding tube that can be easily jointed and separated.

Description of Related Art

When patients have difficulty swallowing, coma, mouth and neck diseases, or surgery, the patients are unable to eat through the mouth by themselves. If the patient's gastrointestinal function is normal, the patient can be fed by a feeding tube with the help of medical persons or families to help the patients obtain the needed calories and nutrients.

The common feeding tube is a long and flexible tube inserted from the nostril through the esophagus to the stomach. If the digestion function of the stomach is not good, the feeding tube can be even inserted into the duodenum. Therefore, the so called gavage by a feeding tube is inserting the feeding tube from the nostril to the stomach, and treating the food to be in a form of liquid. Then, the liquid food is input to the feeding tube and guided by the feeding tube from the nostril into the stomach or the duodenum to reach the eating purpose, and the patient can absorb the needed calories and nutrients.

Since the feeding tube is an invasive medical equipment, and the process of inserting the feeding tube from the nostril to the stomach also has potential risk to the health. Therefore, after inserting the feeding tube to a human body, the feeding tube is usually not removed to avoid the reinsertion and the sanitization problem. Based on this reason, the feeding tube usually has two segments and jointed by the corresponding openings. The segment of the feeding tube outside the nose can be removed, and the segment from the nostril to the stomach is still stayed in the human body to be directly jointed and used next time. Therefore, the reinsertion process can be omitted. However, assembling or separating the two-segment feeding tube jointed by the corresponding openings directly can easily pull the segment of the feeding tube in the human body to cause unwellness of the patient, or even cause the displacement of the feeding tube in the human body. Especially, there is no fixing structure for fixing the feeding tube when the feeding tube is inserted into the stomach or the duodenum. Therefore, the displacement condition can be occurred at any time.

Moreover, when the feeding tube is inserted from the nostril through the esophagus into the stomach or the duodenum, the narrower region of the human inner organs, such as nasopharynx, cardia, and duodenal bulb, will suffer larger compression by the feeding tube to cause unwellness and even compressive mucosal injury. The use of the feeding tube is quite inconvenient.

Furthermore, after the feeding tube entering the human body, the real position of the front end cannot be sensed from outside. Therefore, a condition that the feeding tube may be wound or may not reach the predetermined position is usually occurred. If the gavage is performed, the food may enter other organs of the human body to cause inflammation and other diseases.

At present, the inventor invents this invention in light of the forgoing to provide a new truncated feeding tube.

### SUMMARY

A first aspect of this invention is to provide a truncated feeding tube mainly comprising a first tube and a second tube. A terminal of the second tube is placed in the stomach from the nasal cavity, and the other terminal is connected to one terminal of a joint element. A terminal of the first tube is connected to an input equipment from a fluid supply, and the other terminal is connected to the other terminal of the joint element. The characteristic of joining and separating by the joint element can be used by a patient to remove or joint the second tube depending on the actual needs to provide convenience when going outside or moving. Therefore, the repeatedly removing and installing a feeding tube can be decreased to reduce the unwellness of the patient.

A second aspect of this invention is to provide a truncated feeding tube mainly has a positioning member disposed on a front portion of the second tube, so that an endoscopic technology can be used to clamp the positioning member and the inner wall of the stomach or the duodenum by a hemostatic clip, and the front portion of the second tube is positioned in the stomach or the duodenum to avoid sliding displacement.

A third aspect of this invention is to provide a truncated feeding tube has a protection part corresponding to the narrower region of the human inner organs, such as nasopharynx, cardia, and duodenal bulb to reduce the unwellness of a patient and largely reduce the compression injury of the mucosal.

A fourth aspect of this invention is to provide a truncated feeding tube has a sensing part disposed on a front portion of the feeding tube. In the process of inserting the feeding tube into the human body, the real position of the sensing part can be shown by the irradiation of an X ray machine to indeed place the feeding tube at the predetermined position. Furthermore, a plurality of counterweights is disposed within the sensing part to ensure the front portion of the second tube to keep a sagging state due to gravity to facilitate the insertion of the feeding tube into inside of a human body.

The main aspects and functions of this invention are reached by the following technical means.

A truncated feeding tube comprises a first tube, a second tube, and a joint element. A terminal of the first tube is a first joint end, and a terminal of the second tube is a second joint end. The joint element is a hollow tubular body. A joint part is disposed on the inner wall of the joint element to joint and fix the first joint end and the second joint end simultaneously.

In the truncated feeding tube as described above, a terminal of the second tube has a front portion, at least a hole is located near the peripheral of the front portion of the second tube. A circular positioning member is fixed between the front portion of the second tube and the holes or between at least two holes.

In the truncated feeding tube as described above, the second tube has at least one protection part corresponding to at least one position of nasopharynx, cardia, and duodenal bulb.

In the truncated feeding tube as described above, the recess is further wrapped by a protection layer, wherein the outer diameter of the protection layer is equal to the outer diameter of the second tube without the recessed part to level surfaces of the protection layer and the second tube without the recessed part, wherein the outer diameter of the protection layer is larger than the outer diameter of the second tube without the recessed part, so that the protection layer is protruded, or wherein the outer diameter of the protection layer is smaller than the outer diameter of the second tube without the recessed part, so that the protection layer is recessed.

In the truncated feeding tube as described above, the second tube has a sensing part formed on the front portion thereof and having a light-sensitive metal material to be observed by an irradiation of an X ray machine, and a plurality of counterweights is disposed within the sensing part.

In the truncated feeding tube as described above, the second tube has assistant sensing parts having a light-sensitive metal material.

The advantages of this invention includes:

1. The feeding tube of this invention is designed to have two segments, and the joint element, and the first tube and the second tube can be removably jointed or separated. A patient can joint the first and the second tubes, or remove the second tube, depending on the actual condition. For example, when non-feeding, the first tube can be removed to avoid the first tube hanged outside the nose to attract the attentions of others. Moreover, the patient can directly wear a mask after removing the first tube, so that others can not aware that the patient wears a feeding tube to increase the patient's confidence.

2. In this invention, the first and the second tubes of the feeding tube can be separated. Therefore, when any one of the joint element, the first tube, and the second tube is damaged, the damaged part can be independently replaced. Since it is not needed to replace the feeding tube as a whole, the waste of resources can be avoided.

3. In this invention, since the first tube and the second tube can be separated to reduce the entire length of the feeding tube, the cleaning of the feeding tube is much easier to avoid infections and to be used repeatedly.

4. In this invention, a positioning member is disposed on a front portion of the second tube, so that an endoscopic technology can be used to clamp the positioning member and the inner wall of the stomach or the duodenum by a hemostatic clip, and the front portion of the second tube is positioned in the stomach or the duodenum to avoid sliding displacement.

5. In this invention, the second tube has a protection part corresponding to the narrower region of the human inner organs, such as nasopharynx, cardia, and duodenal bulb to reduce the unwellness of a patient and largely reduce the compression injury of the mucosal.

6. In this invention, a sensing part is disposed on a front portion of the feeding tube. In the process of inserting the feeding tube into the human body, the real position of the sensing part can be shown by the irradiation of a X ray machine to indeed place the feeding tube at the predetermined position.

7. A plurality of counterweights is disposed within the sensing part to ensure the front portion of the second tube to keep a sagging state due to gravity to facilitate insertion of the feeding tube into a human body.

### BRIEF DESCRIPTION OF THE DRAWINGS

FIG. 1 is a perspective exploded view of a truncated feeding tube according to a first embodiment of this invention.

FIG. 2 is an assembly cross-sectional view of a truncated feeding tube according to the first embodiment of this invention.

FIG. 3 is a schematic view of the relative position of a truncated feeding tube according to the first embodiment of this invention.

FIG. 4 is a perspective exploded view of a truncated feeding tube according to a second embodiment of this invention.

FIG. 5 is a perspective exploded view of a truncated feeding tube according to a third embodiment of this invention.

FIG. 6 is a perspective exploded view of a truncated feeding tube according to a fourth embodiment of this invention.

FIG. 7 is a perspective exploded view of a truncated feeding tube according to a fifth embodiment of this invention.

FIG. 8 is a perspective exploded view of a truncated feeding tube according to a sixth embodiment of this invention.

FIG. 9 is a perspective exploded view of a truncated feeding tube according to a seventh embodiment of this invention.

FIG. 10 is an assembly cross-sectional view of a truncated feeding tube according to the seventh embodiment of this invention.

FIG. 11 is an assembly cross-sectional view of a truncated feeding tube according to the eighth embodiment of this invention.

FIG. 12 is a perspective exploded view of a truncated feeding tube according to a ninth embodiment of this invention.

FIG. 13 is a perspective view of a truncated feeding tube according to a tenth embodiment of this invention.

FIG. 14 is a lateral and partially enlarged view of a truncated feeding tube according to an eleventh embodiment of this invention.

### DETAILED DESCRIPTION

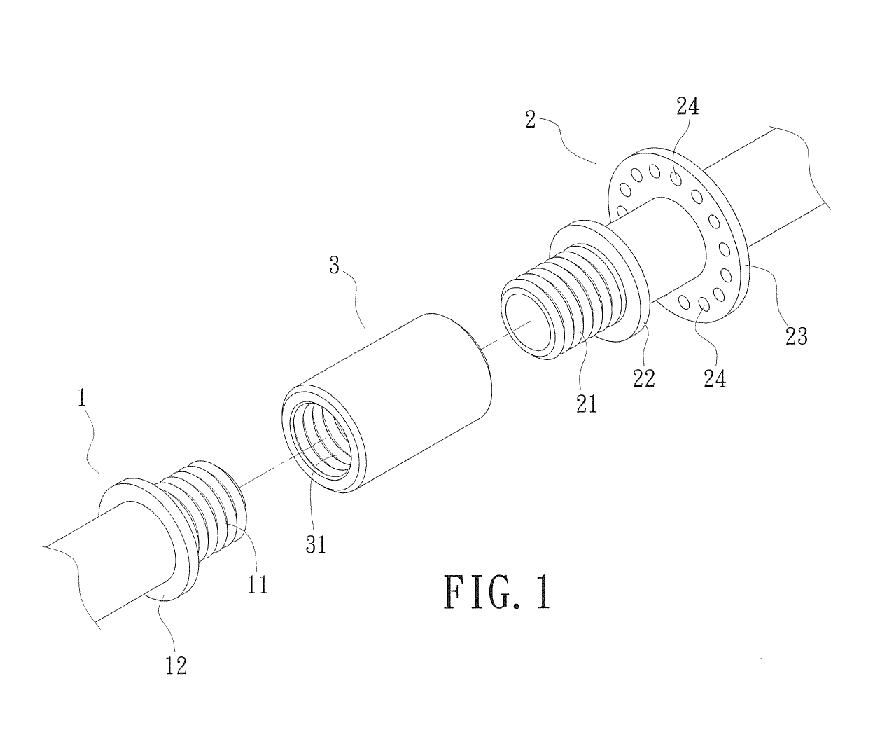

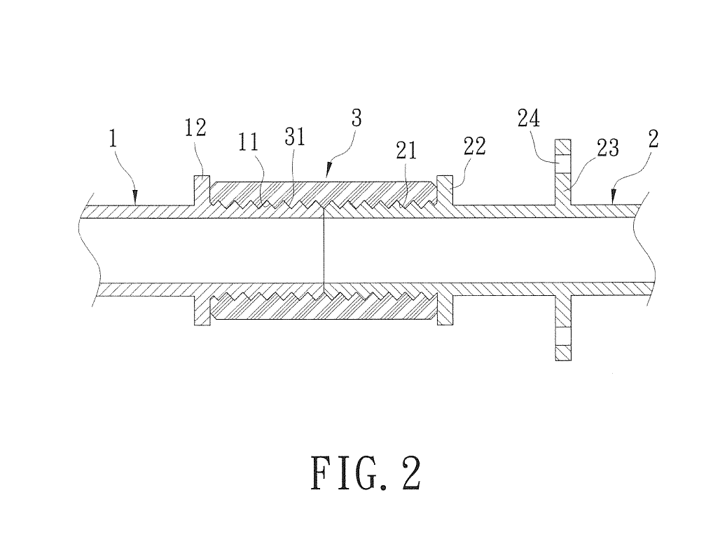

Please refer to FIGS. 1 and 2.

The truncated feeding tube of this invention comprises a first tube 1, a second tube 2, and a joint element 3, wherein

one end of the first tube 1 is a first joint end 11, which is a thread segment in this embodiment;

one end of the second tube 2 is a second joint end 21, which is a thread segment in this embodiment;

the joint element 3 is a hollow tubular structure having a joint part 31 on an inner wall of the joint element 3; in this embodiment, the joint part 31 is a thread segment; the two ends of the joint part 31 are used to respectively joint the first joint end 11 and the second joint end 21.

In this embodiment, the joint element 3 uses the two ends of the joint part 31 to respectively lock the threaded first joint end 11 of the first tube 1 and the threaded second joint end 21 of the second tube 2. The first tube 1 and the second tube 2 are locked and connected by the joint element 3 to form an inner channel for delivering liquid food.

In this invention, a first stop ring 12 is further disposed on the outer wall of the first tube 1 near the first joint end 11. A second stop ring 22 is disposed on the outer wall of the second tube 2 near the second joint end 21. A third stop ring 23 is disposed on the outer wall of the second tube 2 at a distance from the second stop ring 22. Many holes 24 are disposed on and penetrate the third stop ring 23.

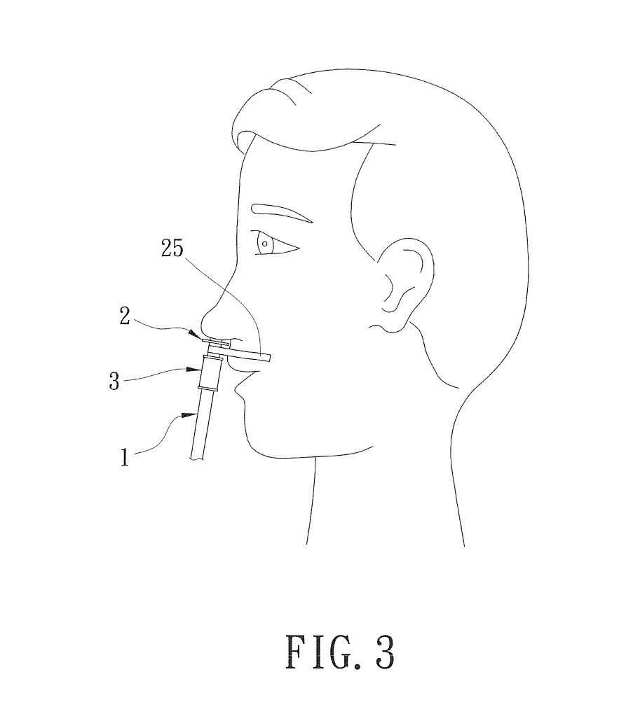

The first stop ring 12 and the second stop ring 22 are used to limit a distance for locking the first tube 1, the second tube 2 and the joint element 3. The diameter of the third stop ring 23 is larger than the diameter of the nostril to limit the feeding tube's length inside a human body. The holes 24 can avoid the third stop ring 23 shielding the nostril to obstruct a patient's respiratory. Please refer to FIG. 3.

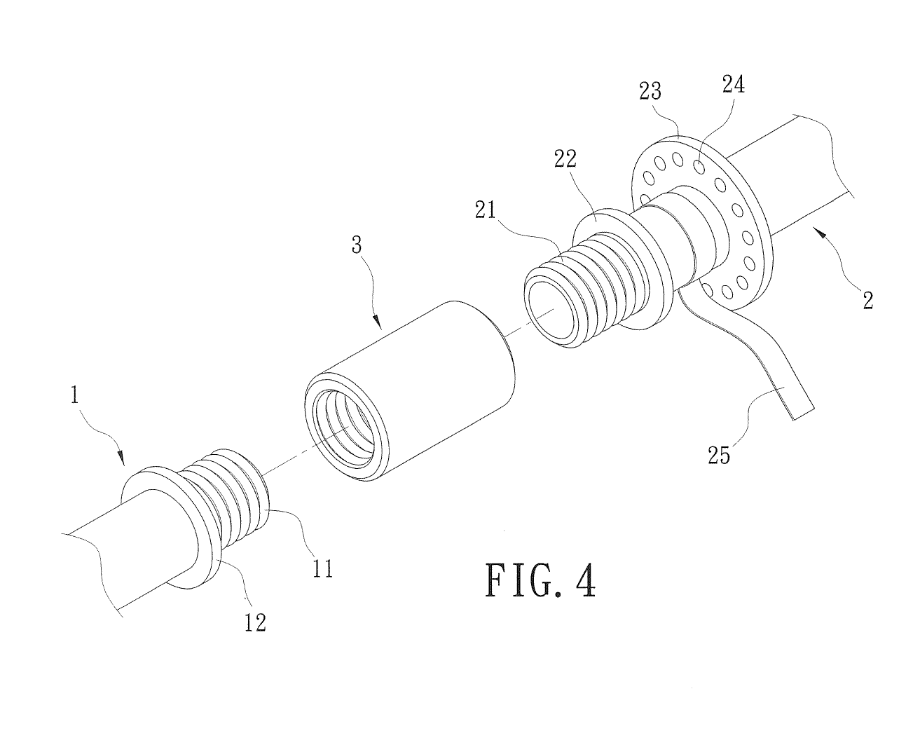

Next, a belt 25 is disposed on the second tube 2 at a position between the second stop ring 22 and the third stop ring 23. A trade mark may be printed on the belt 25. Please refer to FIG. 4.

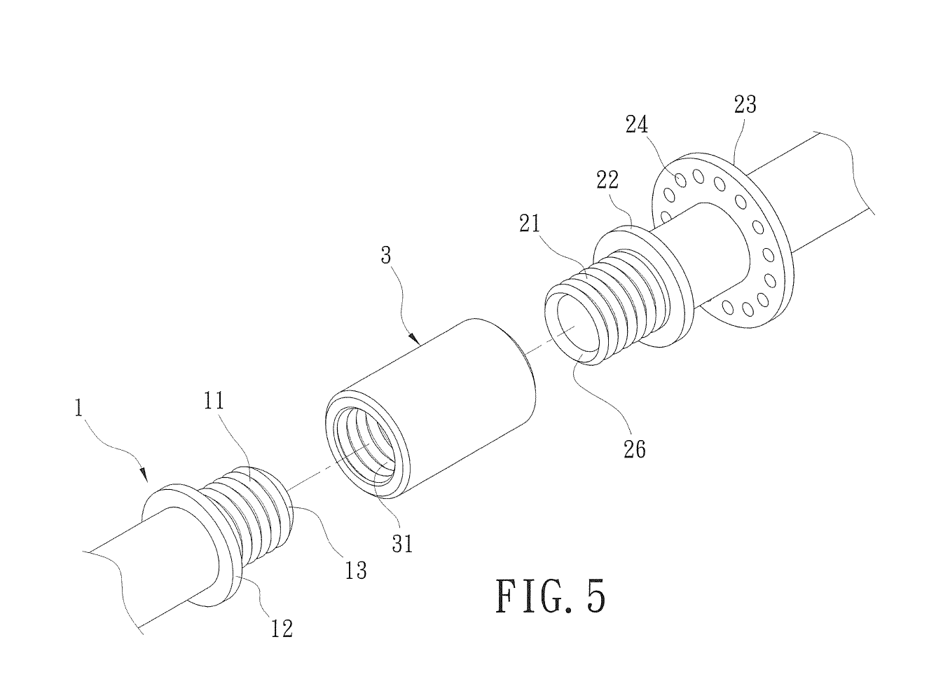

Please refer to FIG. 5. First concave and convex joint parts 13, 26 are respectively formed on the openings of the first joint end 11 and the second joint end 21. The connection of the first concave and convex joint parts 13, 26 used to connect the first tube 1 and the second tube 2 has leakage preventing effect.

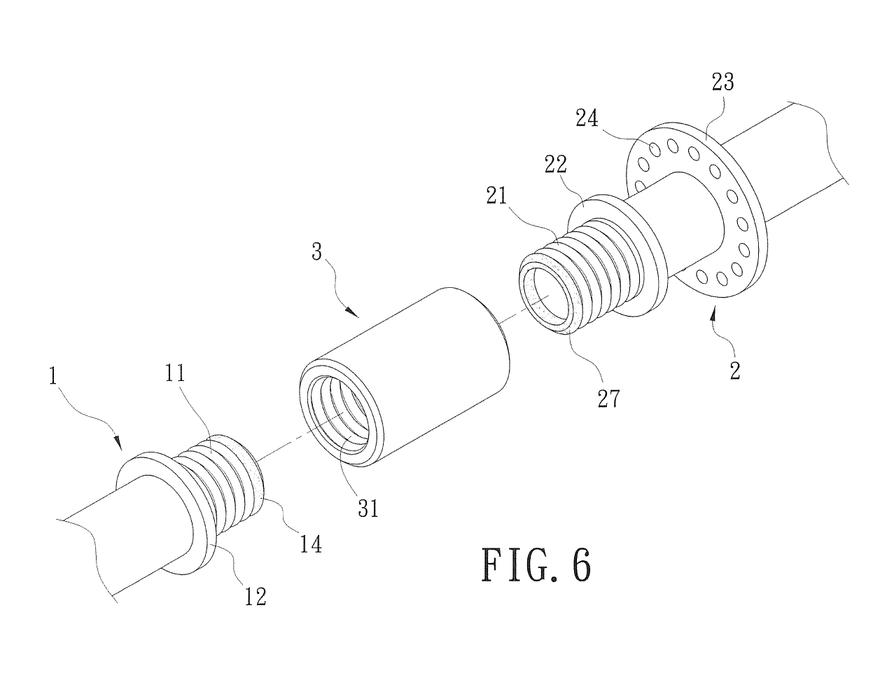

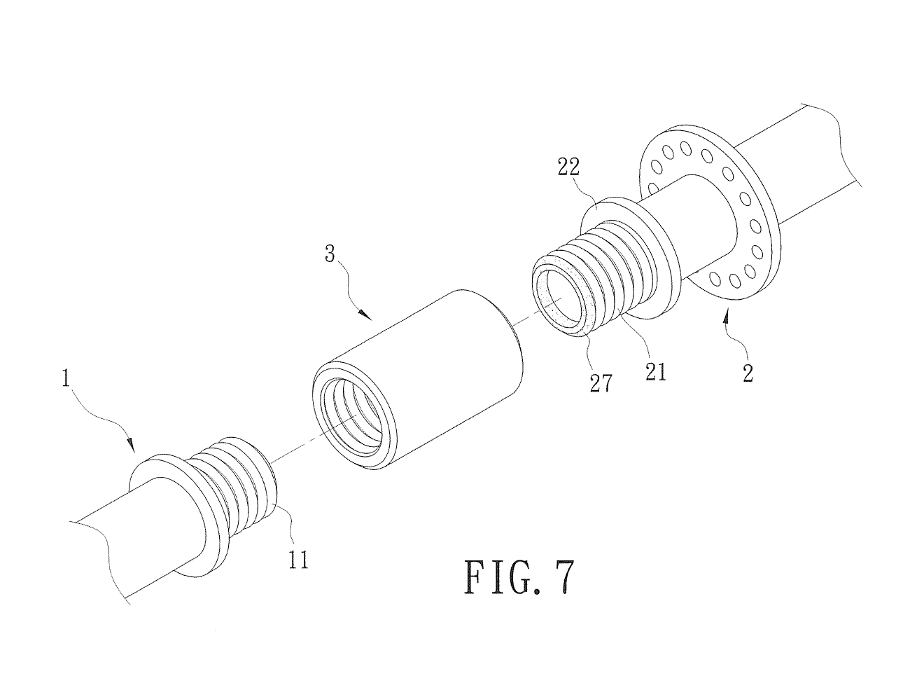

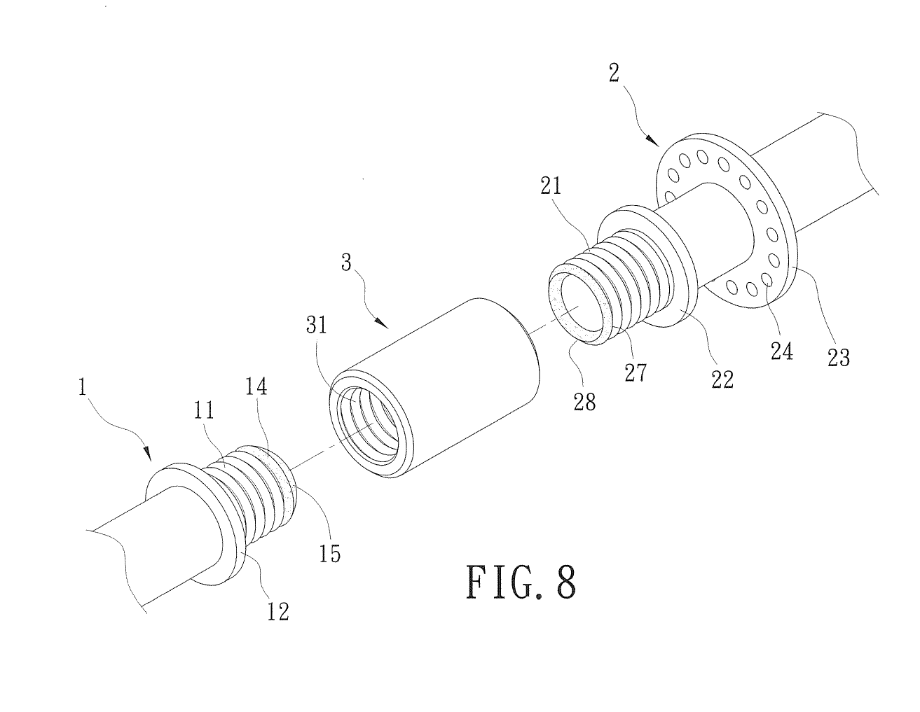

Please refer to FIG. 6. Hermetic rings 14, 27 are respectively disposed on the openings of the first joint end 11 and the second joint end 21. The softness and elasticity of the two hermetic rings 14, 27 are used to connect the first tube 1 and the second tube 2 to have good leakage preventing effect. Of course, only one hermetic ring 14 or 27 on the first joint end 11 or the second joint end 21 is also allowed, please refer to FIG. 7. Furthermore, the two hermetic rings 14, 27 can also have second concave and convex joint parts 15, 28 to increase the leakage preventing effect between the connection of the first tube 1 and the second tube 2. Please refer to FIG. 8.

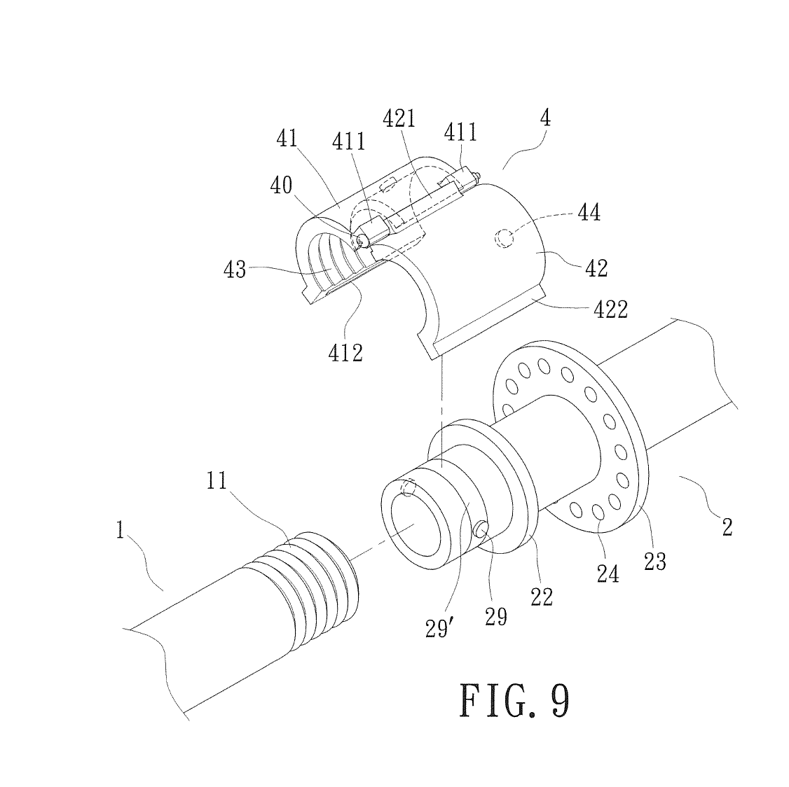

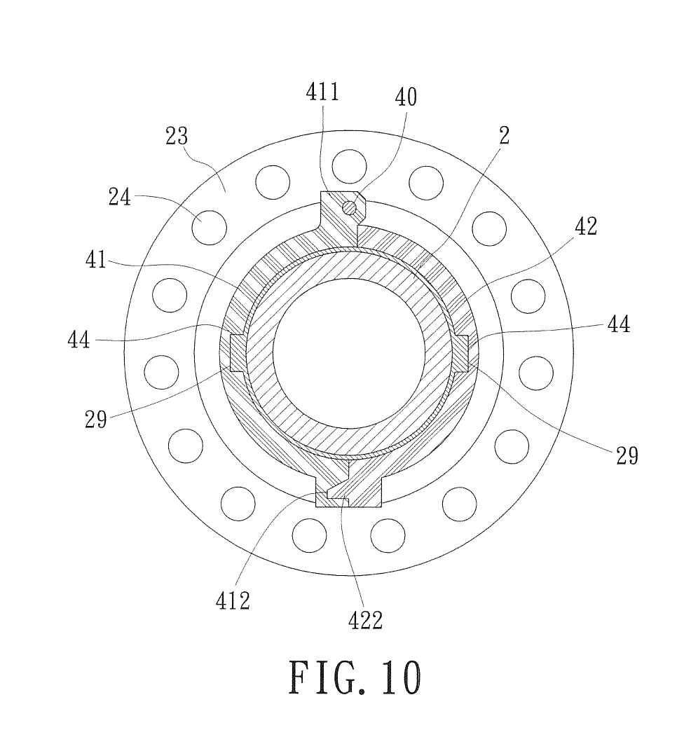

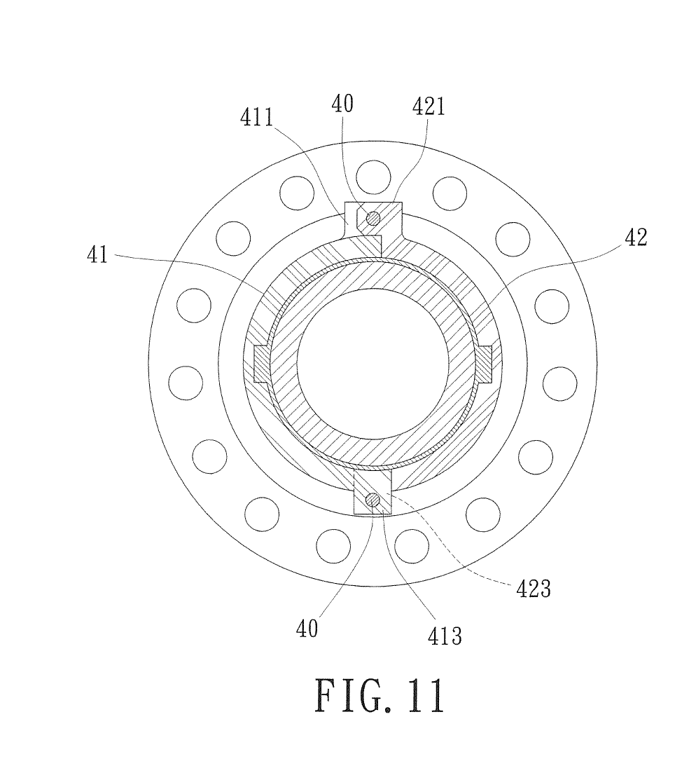

Please refer to FIGS. 9 and 10. In the truncated feeding tube of this invention, the first joint end 11 of the first tube 1 is a thread segment, and the second joint end 29 of the second tube 2 is bumps. A joint element 4 comprises a first cover shell 41 and a second cover shell 42. One corresponding sides of the first cover shell 41 and the second cover shell 42 are pivotally jointed, and the other corresponding sides are engaged and fixed to form a hollow tubular body. That is, pivoting ear parts 411, 421 are disposed on the corresponding sides of the first cover shell 41 and the second cover shell 42, and a pivot 40 is passed through the pivoting ear parts 411, 421 to pivotally connect the corresponding sides of the first cover shell 41 and the second cover shell 42. A hooking hole 412 and a hook 422 are disposed on the other corresponding sides of the first cover shell 41 and the second cover shell 42. Therefore, the other corresponding sides of the first cover shell 41 and the second cover shell 42 can be fastened by the hooking hole 412 and the hook 422. As shown in FIG. 11, the other corresponding sides of the first cover shell 41 and the second cover shell 42 may be also pivotally fastened to let the first cover shell 41 and the second cover shell 42 form a hollow tubular body. That is, pivoting ear parts 413, 423 are disposed on the other corresponding sides of the first cover shell 41 and the second cover shell 42, and another pivot 40 is passed through the pivoting ear parts 413, 423 to pivotally connect the other corresponding sides of the first cover shell 41 and the second cover shell 42. A first joint part 43 and a second joint part 44 are disposed on the inner wall of the joint element 4. The first joint part 43 joints the first joint end 11, and the second joint part 44 joints the second joint end 29. In this embodiment the first joint part 43 is a thread segment to lock the threaded first joint end 11, and the second joint part 44 is recessed holes to lock the bumps of the second joint end 29. Accordingly, the first tube 1 and the second tube 2 can be jointed by the joint element 4 to form a feeding tube for delivering liquid food.

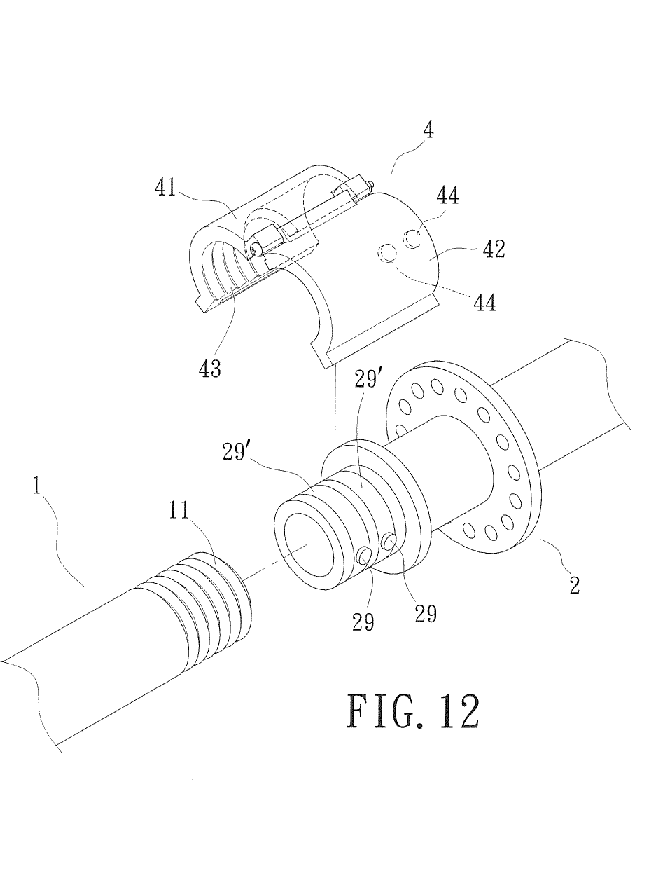

Among them, the bumps of the second joint end 29 are formed on a holding band 29′ fixed on the second tube 2, and the number of the holding band 29′ may be 1 or 2. As shown in FIG. 9, one holding band 29′ is installed. As shown in FIG. 12, two holding bands 29′ are installed, and the number of the bumps on the second joint end 29 is also increased as the number of the holding bands 29′ is increased. Of course, the number of the recessed holes on the second joint part 44 of the joint element 4 is also increased correspondingly.

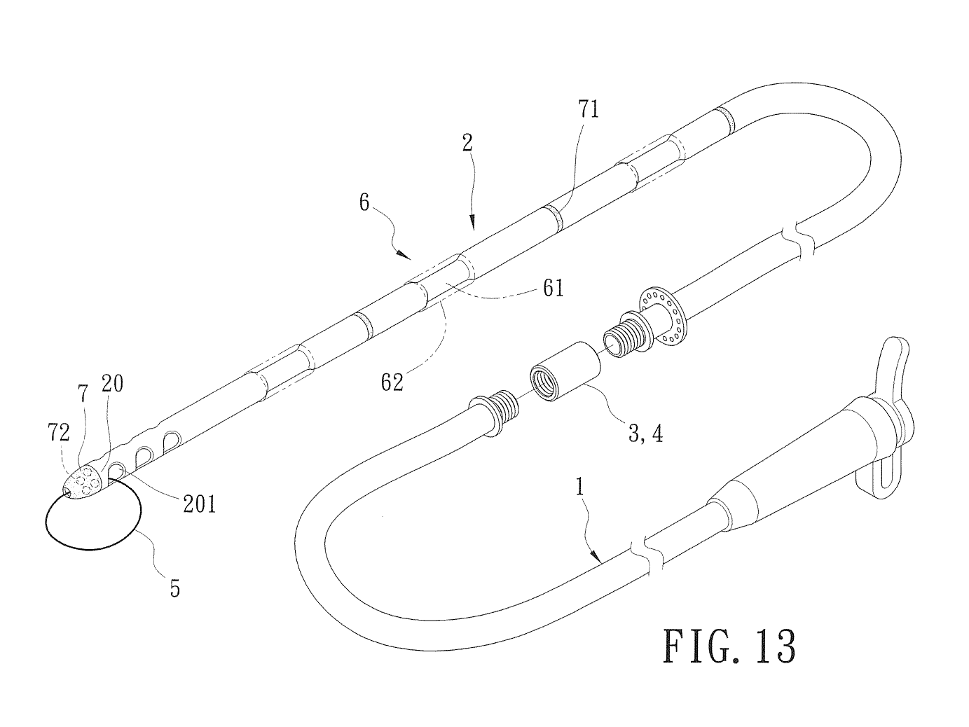

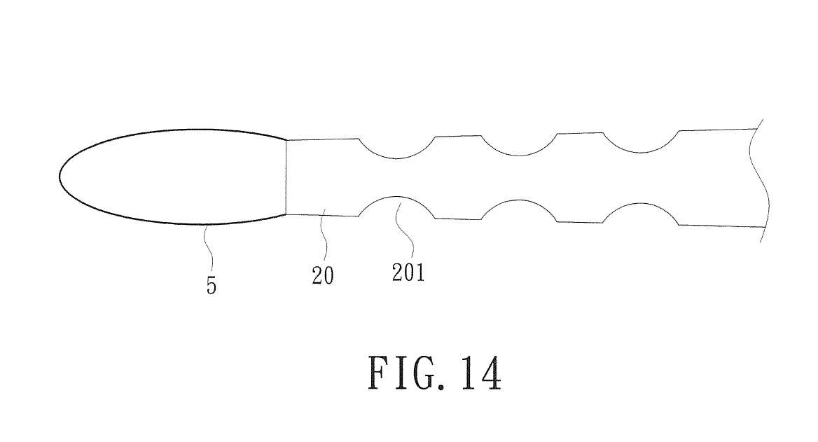

Please refer to FIG. 13. In this invention, a front portion 20 of the second tube 2 is formed on one end of the second tube 2. The front portion 20 of the second tube 2 has a round head or a flat head. At least one hole 201 is disposed near the front portion 20 of the second tube 2, and a circular positioning member 5 is disposed on the front portion 20 of the second tube 2. The positioning member 5 is passed through the terminal of the front portion 20 of the second tube 2 and one of the holes 201, or passed through any two of the holes 201. As shown in FIG. 14, the positioning member 5 can be also directly formed on two sides of the terminal of the front portion 20 of the second tube 2 as one piece.

As a result, when the front portion 20 of the second tube 2 of the second tube 2 is inserted from nostril through esophagus to stomach, or even to the duodenum, an endoscopic technology can be used to clamp the positioning member 5 of the front portion 20 of the second tube 2 and the inner wall of the stomach or the duodenum by a hemostatic clip, and the front portion 20 of the second tube 2 is indeed positioned in the stomach or the duodenum to avoid sliding displacement.

Please refer to FIG. 13. In a part of the tube 2 corresponding to the narrower region of the human inner organs, such as nasopharynx, cardia and duodenal bulb, a protection part 6 is installed. The protection part 6 is a recessed part 61 directly formed on the second tube 2. A protection layer 62 may be further cover the recessed part 61. The material of the protection layer 62 may be a material that can reduce the compression injury of the mucosal. Moreover, the outer diameter of the protection layer 62 is equal to the outer diameter of the second tube 2 without the recessed part 61 to level the surfaces of the protection layer 62 and the second tube 2 without the recessed part 61. The outer diameter of the protection layer 62 also can be larger than the outer diameter of the second tube 2 without the recessed part 61, so that the protection layer 62 is protruded. The outer diameter of the protection layer 62 also can be smaller than the outer diameter of the second tube 2 without the recessed part 61, so that the protection layer 62 is recessed.

Please refer to FIG. 13. A sensing part 7 is disposed on the front portion 20 of the second tube 2, and many assistant sensing parts 71 are disposed on the second tube 2. The sensing part 7 and the assistant sensing parts 71 all have a light-sensitive metal material to be observed by a X ray machine.

The sensing part 7 may wrap the outer side of the front portion 20 of the second tube 2, or is formed on the outer side of the front portion 20 of the second tube 2, such as is directly formed on the front terminal of the front portion 20 of the second tube 2. As a result, in the process of inserting the front portion 20 of the second tube 2 from nostril through esophagus to stomach, or even to the duodenum, the real positions of the sensing part 7 and the assistant sensing parts 71 can be observed by the irradiation of a X ray machine to indeed place the front portion 20 of the second tube 2 at the predetermined position.

A plurality of counterweights 72 is disposed within the sensing part 7 to ensure the front portion 20 of the second tube 2 to keep a sagging state due to gravity to facilitate insertion of the feeding tube into a human body.

What is claimed is:

1. A truncated feeding tube, comprising:
a first tube having a first joint end at one terminal thereof;
a second tube having a second joint end at one terminal thereof; and
a joint element, which is a hollow tubular body, and a joint part disposed on an inner wall of the joint element, wherein the joint part joint and fix the first joint end and the second joint end simultaneously.

2. The truncated feeding tube of the claim 1, wherein the first joint end and the second joint end are thread segments, and the first joint end and the second joint end are locked on two terminals of the joint element.

3. The truncated feeding tube of the claim 1, wherein the joint element comprises:
a first cover shell and a second cover shell, wherein corresponding sides of the first cover shell and the second cover shell are pivotally connected, and the other corresponding sides are engaged and fixed to form a hollow tubular body; and
a first joint part and a second joint part disposed on an inner wall of the joint element,
wherein the first joint part joints the first joint end, the second joint part joints the second joint end, and the first joint end and the first joint part are thread segments and can be locked each other, and
wherein the second joint part is a recessed hole, the second joint end is a bump, and the recessed hole and the bump are intercalated and fixed.

4. The truncated feeding tube of claim 3, wherein the bump is formed on a holding band fixed on the second joint end of the second tube.

5. The truncated feeding tube of claim 1, wherein an outer tubular surface of the first tube has a first stop ring protruded therefrom and near the first joint end.

6. The truncated feeding tube of claim 5, wherein an outer tubular surface of the second tube has a second stop ring protruded therefrom and near the second joint end.

7. The truncated feeding tube of claim 6, wherein the outer wall of the second tube has a third stop ring protruded therefrom and located at a distance from the second stop ring, and the third stop ring has plural holes penetrating through the third stop ring.

8. The truncated feeding tube of claim 7, wherein the second tube has a belt disposed between the second stop ring and the third stop ring.

9. The truncated feeding tube of claim 1, wherein openings of the first joint end and the second joint end have first concave and convex joint parts, hermetic rings jointed each other, or hermetic rings jointed each other and having second concave and convex joint parts formed on the hermetic rings.

10. The truncated feeding tube of claim 1, wherein the second tube has a front portion formed on one terminal thereof, at least one hole is formed near a peripheral of the front portion of the second tube, and a circular positioning member is fixed on the front portion of the second tube and the hole or between at least two of the holes.

11. The truncated feeding tube of claim 10, wherein the front portion of the second tube has a round head or a flat head.

12. The truncated feeding tube of claim 11, wherein the positioning member and the front portion of the second tube are formed as one piece.

13. The truncated feeding tube of claim 12, wherein the second tube has at least a protection part corresponding to at least one position of nasopharynx, cardia, and duodenal bulb.

14. The truncated feeding tube of claim 13, wherein the protection part is a recess formed on the second tube.

15. The truncated feeding tube of claim 14, wherein the recess is further wrapped by a protection layer, wherein the outer diameter of the protection layer is equal to the outer diameter of the second tube without a recessed part to level surfaces of the protection layer and the second tube without the recessed part, wherein the outer diameter of the protection layer is larger than the outer diameter of the second tube without the recessed part, so that the protection layer is protruded, or wherein the outer diameter of the protection layer is smaller than the outer diameter of the second tube without the recessed part, so that the protection layer is recessed, and wherein a plurality of counterweights is disposed within the sensing part.

16. The truncated feeding tube of claim 15, wherein the second tube has a sensing part formed on the front portion of the second tube thereof and having a light-sensitive metal material to be observed in an irradiation of a X ray machine.

17. The truncated feeding tube of claim 16, wherein the sensing part wrap the outer side of the front portion of the second tube.

18. The truncated feeding tube of claim 17, wherein the sensing part is formed at the outer side of the front portion of the second tube as one piece, or connected to the outer side of the front portion of the second tube.

19. The truncated feeding tube of claim 18, wherein the second tube has assistant sensing parts having a light-sensitive metal material.
